(19) United States
(12) Patent Application Publication
(10) Pub. No.: US 2009/0116219 A1
(43) Pub. Date: May 7, 2009

(54) PRISM SHEET AND BACKLIGHT MODULE USING THE SAME

(75) Inventor: SHAO-HAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/957,491

(22) Filed: Dec. 17, 2007

(30) Foreign Application Priority Data
Oct. 9, 2007 (CN) 200710201984.X

(51) Int. Cl. G09F 13/08; G02B 5/04

(52) U.S. Cl. 362/97.1; 359/831

(57) ABSTRACT

An exemplary prism sheet includes a transparent main body. The transparent main body includes a surface and a plurality of spherical micro-depressions integrally formed in the surface. A backlight module using the present prism sheet is also provided.

### CROSS-REFERENCE TO RELATED APPLICATIONS

This application is related to seven co-pending U.S. patent applications, which are: application Ser. No. 11/933,439 and Ser. No. 11/933,441, filed on Nov. 1, 2007, and both entitled “PRISM SHEET AND LIQUID CRYSTAL DISPLAY DEVICE USING THE SAME”, application Ser. No. 11/946,860 and Ser. No. 11/946,862, filed on Nov. 29, 2007, and both entitled “PRISM SHEET AND LIQUID CRYSTAL DISPLAY DEVICE USING THE SAME”, application Ser. No. 11/949,056, filed on Dec. 3, 2007, and entitled “PRISM SHEET AND LIQUID CRYSTAL DISPLAY DEVICE USING THE SAME”, application Ser. No. 11/949,057, filed on Dec. 3, 2007, entitled “PRISM SHEET AND BACKLIGHT MODULE USING THE SAME”, and application Ser. No. [to be determined], with Attorney Docket No. US15181 and Attorney Docket No. US15182, and both entitled “PRISM SHEET AND LIQUID CRYSTAL DISPLAY DEVICE USING THE SAME”. In all these co-pending applications, the inventor is Shao-Han Chang. All of the co-pending applications have the same assignee as the present application. The disclosures of the above identified applications are incorporated herein by reference.

### BACKGROUND OF THE INVENTION

1. Field of the Invention

The present invention relates to prism sheets, and particularly, to a prism sheet used in a backlight module.

2. Discussion of the Related Art

In a liquid crystal display device (LCD device), liquid crystal is a substance that does not illuminate light by itself. Instead, the liquid crystal propagates on light received from a light source, in order that the liquid crystal can provide displaying of information. In the case of a typical liquid crystal display device, a backlight module powered by electricity supplies the needed light.

FIG. 6 is an exploded, side cross-sectional view of a typical liquid crystal display device 100 employing a typical prism sheet 10. The liquid crystal display device 100 includes a housing 11 and a plurality of lamps 12 positioned in the housing 11. The liquid crystal display device 100 further includes a light diffusion plate 13, a prism sheet 10, and a LCD panel (not shown) stacked on the housing 11 in that order. The prism sheet 10 includes a base layer 101 and a prism layer 103 formed on the base layer 101. The prism layer 103 has a plurality of prism lenses 105 each having a triangular cross section. The prism lenses 105 are arranged regularly, and each extends along a direction parallel to an edge of the prism sheet 10. In use, light emitted from the lamps 12 enters the prism sheet 10 after scattered in the diffusion plate 13. The light is refracted and concentrated by the prism lenses 105 of the prism sheet 10 before leaving the prism sheet 10 towards the LCD panel.

Generally, a method of manufacturing the prism sheet 10 includes the following steps. First, a melted ultraviolet (UV)-cured transparent resin is coated on the base layer 101, and then the melted ultraviolet-cured transparent resin is solidified to form the prism layer 103 having prism lenses 105. This results in that the prism lenses 105 of the prism layer 103 are usually damaged or scratched due to the poor rigidity and mechanical strength of the transparent resin.

In order to protect the prism layer 103 of the prism sheet 10 in use, the liquid crystal display device 100 usually further includes an upper light diffusion film 14 disposed on the prism sheet 10. Although the upper light diffusion film 14 and the prism sheet 10 are in contact with each other, a plurality of air pockets still exist at the boundary between the light diffusion film 14 and the prism sheet 10. When the liquid crystal display device 100 is in use, light passes through the air pockets, and some of the light undergoes total reflection at one or another of the corresponding boundaries. In addition, the upper light diffusion film 14 may absorb an amount of the light from the prism sheet 10. As a result, a brightness of light illumination of the liquid crystal display device 100 is reduced.

Therefore, a new prism sheet is desired in order to overcome the above-described shortcomings.

### SUMMARY

In one aspect, a prism sheet according to a preferred embodiment includes a transparent main body. The transparent main body includes a surface and a plurality of spherical micro-depressions integrally formed in the surface of the transparent main body.

In another aspect, a backlight module according to a preferred embodiment includes a plurality of lamps, a light diffusion plate and a prism sheet. The light diffusion plate is disposed above the lamps and the prism sheet is stacked on the light diffusion plate. The prism sheet is the same as described in a previous paragraph. The surface defining spherical micro-depressions faces away from the light diffusion plate.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and backlight module. Moreover, in the drawings, like reference numerals designate corresponding parts throughout several views, and all the views are schematic.

FIG. 1 is a side, cross-sectional view of a backlight module using a prism sheet according to a first preferred embodiment of the present invention.

FIG. 2 is an isometric view of the prism sheet of FIG. 1.

FIG. 3 is a side, cross-sectional view of the prism sheet of FIG. 2, taken along line III-III thereof.

FIG. 4 is a top plane view of a prism sheet according to a second preferred embodiment of the present invention.

FIG. 5 is a top plane view of a prism sheet according to a third preferred embodiment of the present invention.

FIG. 6 is side, cross-sectional view of a conventional backlight module using a typical prism sheet.

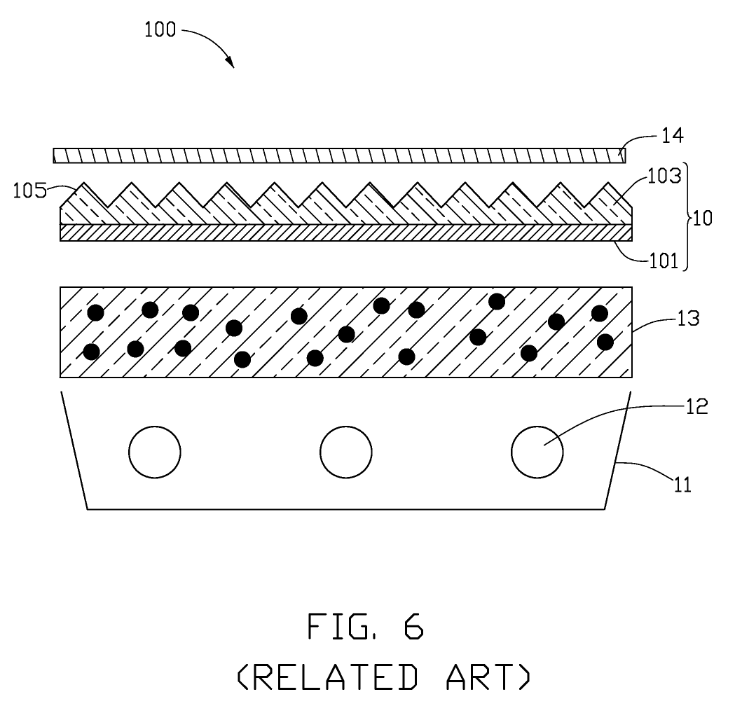

### DETAILED DESCRIPTION OF THE PREFERRED EMBODIMENTS

Reference will now be made to the drawings to describe preferred embodiments of the present prism sheet and backlight module, in detail.

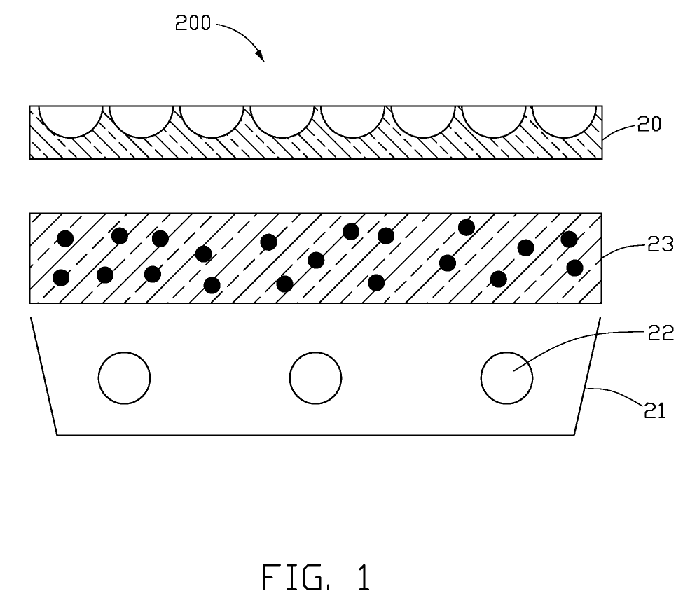

Referring to FIG. 1, a backlight module 200 in accordance with a first preferred embodiment of the present invention is shown. The backlight module 200 includes a prism sheet 20, a housing 21, a plurality of lamps 22, and a light diffusion plate 23. The lamps 22 are regularly aligned above a base of the housing 21. The light diffusion plate 23 and the prism sheet 20 are stacked on the top of the housing 21 in that order.

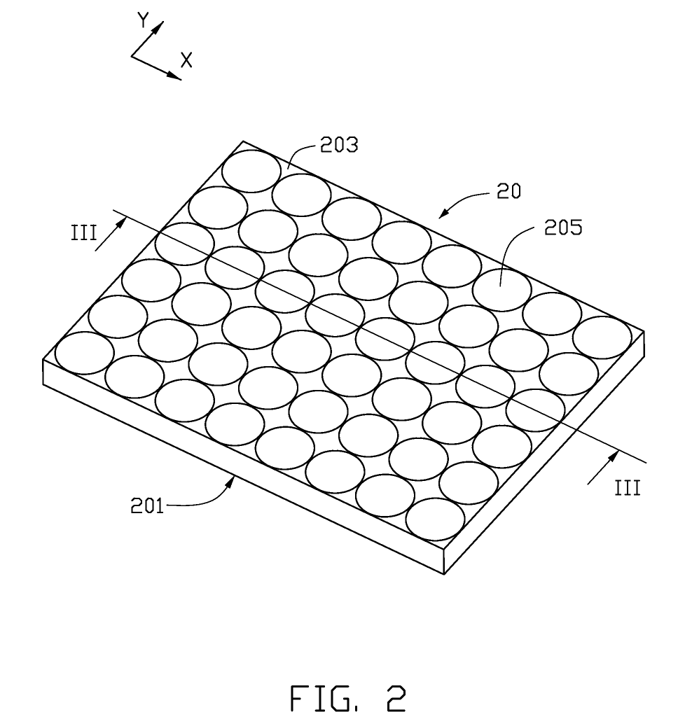

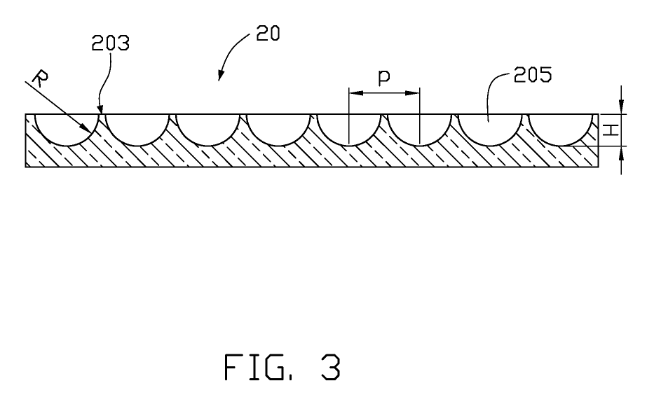

Referring to FIGS. 2 and 3, the prism sheet 20 includes a transparent main body. The transparent main body includes a light input surface 201 and a light output surface 203. The light input surface 201 and the light output surface 203 are on opposite sides of the main body. A plurality of spherical micro-depressions 205 are formed in the light output surface 203. The prism sheet 20 is integrally formed by injection molding technology. The prism sheet 20 is positioned on the light diffusion plate 23 in a way such that the light input surface 201 is adjacent to the light diffusion plate 23 and the light output surface 203 faces away from the light diffusion plate 23.

In a first embodiment, the spherical micro-depressions 205 are formed in the light output surface 203 of the prism sheet 20 in a matrix manner. The rows and columns of the spherical micro-depressions 205 in the matrix are parallel to the edges of the prism sheet 20 (along an X-direction or a Y-direction) correspondingly. A pitch P between adjacent centers of the micro-depressions 205 is configured to be in the range from about 0.025 millimeters to about 1.5 millimeters. A radius R of each spherical micro-depression 205 is in the range from about a quarter of the pitch P to about double the pitch P, in other words, the radius R of each spherical micro-depression 205 is in relation to the pitch P between adjacent micro-depressions 205. A depth H of each spherical micro-depression 205 relative to the light output surface 203 is in the range from about 0.01 millimeters to the radius R. In this embodiment, the depth H is equal to the radius R. It should be noted that each spherical micro-depression 205 can be a part of a hemisphere micro-depression 205.

The light input surface 201 can be either a planar surface or a rough surface. The spherical micro-depressions 205 of the light output surface 203 are configured for converging the received light emitted from the light output surface 203. A thickness of the prism sheet 20 is greater than that of a conventional prism sheet. The thickness of the prism sheet 20 is preferably in the range from about 0.2 millimeters to about 2 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Referring to FIG. 1 again, the lamps 22 can be point light sources such as light emitting diodes or linear light sources such as cold cathode fluorescent lamps. Even though the housing 21 is made of high reflectivity material, an extra coating can be further applied on the interior. In this embodiment, the lamps 22 are cold cathode fluorescent lamps. The housing 21 is made of a high reflectivity metal.

When compared with the conventional prism sheet, the prism sheet 20 is easier to mass produce because the prism lenses of the conventional prism sheet is manufactured by solidifying melted ultraviolet-cured transparent resin whereas the prism sheet 20 is manufactured by injection molding. The prism lenses made by ultraviolet-cured transparent resin are usually damaged or scratched due to poor rigidity, mechanical strength, and the abrasive properties of the transparent resin. However, the prism sheet 20 of the present invention has better rigidity, mechanical strength, and abrasive properties. Therefore, the present prism sheet is not easily damaged or scratched.

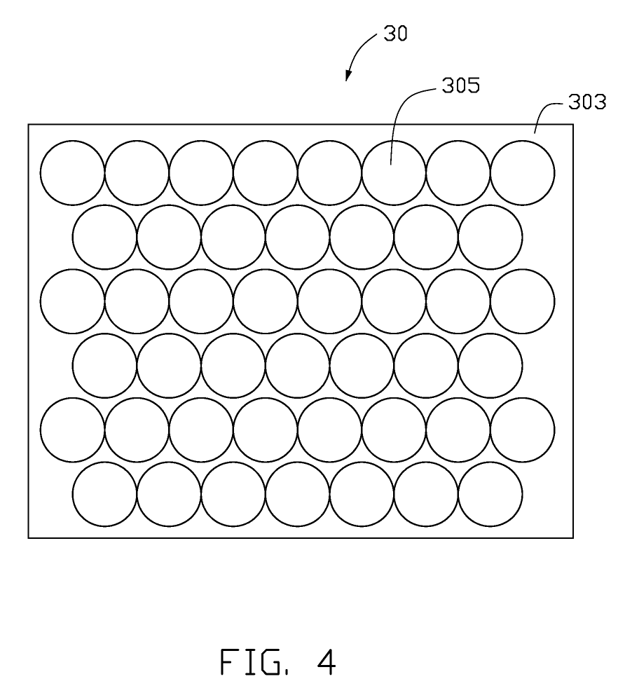

Referring to FIG. 4, a prism sheet 30 in accordance with a second preferred embodiment of the present invention is shown. The prism sheet 30 is similar in principle to the prism sheet 20. A plurality of spherical micro-depressions 305 are formed in a light output surface 303 in a series of micro-depressions rows. Adjacent spherical micro-depressions 305 in a same micro-depressions row are connected with each other. Every other micro-depressions row offset adjacent micro-depressions row in a same predetermined manner. Thus a matrix comprised of offset rows of the spherical micro-depressions 305 is formed. This configuration means that all the spherical micro-depressions 305 in the matrix are arranged relatively compactly together.

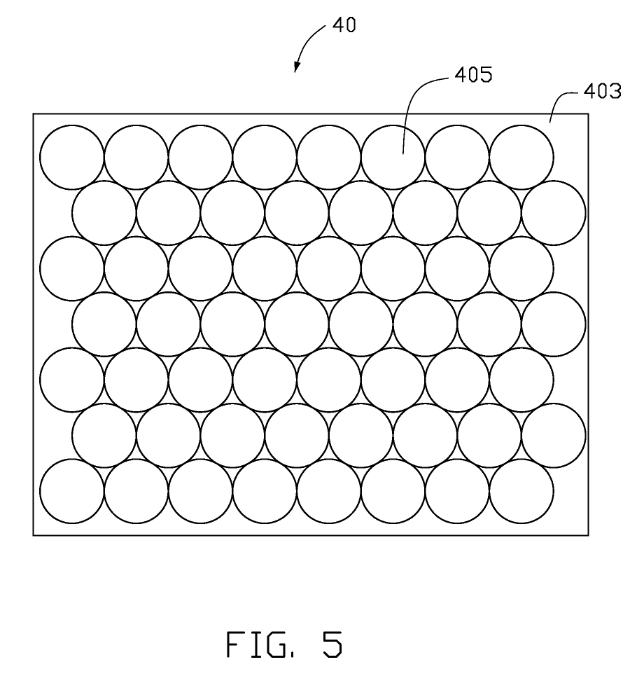

Referring to FIG. 5, a prism sheet 40 according to a third embodiment is shown. The prism sheet 40 is similar in principle to the prism sheet 30 of the second embodiment. A plurality of spherical micro-depressions 405 are formed in a light output surface in a series of micro-depressions rows. The spherical micro-depressions 405 in a same micro-depressions row are connected with each other. Every other micro-depressions row offset adjacent micro-depressions row in a same predetermined manner. Further, spherical micro-depressions 405 of each row are connected to corresponding spherical micro-depressions 405 of adjacent row correspondingly. Thus a regular matrix comprised of offset rows of spherical micro-depressions 405 is formed. This configuration means that all the spherical micro-depressions 405 in the matrix are arranged compactly together.

It should be understood that the spherical micro-depressions of the present prism sheet are not limited to being aligned regularly in a matrix. The spherical micro-depressions can alternatively be arranged according to other suitable patterns, or can alternatively be arranged randomly.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet comprising:
a transparent main body, the transparent main body including
a surface, and
a plurality of spherical micro-depressions integrally formed in the surface.

2. The prism sheet according to claim 1, wherein a radius of each spherical micro-depression is in the range from about 0.01 millimeters to about 3 millimeters.

3. The prism sheet according to claim 2, wherein a height of each spherical micro-depression is configured to be in the range from 0.01 millimeters to the radius of each spherical micro-depression.

4. The prism sheet according to claim 1, wherein a pitch between adjacent centers of the spherical micro-depressions is in the range from about 0.025 millimeters to about 1.5 millimeters.

5. The prism sheet according to claim 1, wherein a thickness of the prism sheet is in a range from about 0.2 millimeters to about 2 millimeters.

6. The prism sheet according to claim 1, wherein the spherical micro-depressions are formed in the surface in a matrix manner.

7. The prism sheet according to claim 1, wherein the prism sheet is made of transparent material selected from the group consisting of polycarbonate, polymethyl methacrylate, polystyrene, copolymer of methylmethacrylate and styrene, and any combination thereof.

8. A backlight module comprising:
a plurality of lamps;
a light diffusion plate disposed above the lamps; and
a prism sheet disposed on the light diffusion plate, the prism sheet including a transparent main body having
a surface facing away from the light diffusion plate, and
a plurality of spherical micro-depressions integrally formed in the surface.

9. The backlight module according to claim 8, wherein a radius of each spherical micro-depression is in the range from about 0.01 millimeters to about 3 millimeters.

10. The backlight module according to claim 9, wherein a height of each spherical micro-depression is configured to be in the range from 0.01 millimeters to the radius of each spherical micro-depression.

11. The backlight module according to claim 8, wherein a pitch between adjacent centers of the spherical micro-depressions is in the range from about 0.025 millimeters to about 1.5 millimeters.

12. The backlight module according to claim 8, wherein a thickness of the prism sheet is in a range from about 0.2 millimeters to about 2 millimeters.

13. The backlight module according to claim 8, wherein the spherical micro-depressions are distributed on the surface in a matrix manner.

14. The backlight module according to claim 8, wherein the prism sheet is made of transparent material selected from the group consisting of polycarbonate, polymethyl methacrylate, polystyrene, copolymer of methylmethacrylate and styrene, and any combination thereof.

15. The backlight module according to claim 8, wherein the surface of the prism sheet is a light output surface facing away from the light diffusion plate.
